(19) United States
(12) Patent Application Publication
(10) Pub. No.: US 2009/0226245 A1
(43) Pub. Date: Sep. 10, 2009

(54) ROTATION SUPPORTING MECHANISM AND PORTABLE TERMINAL

(75) Inventors: Satoshi Takamori, Kyoto (JP); Masami Nishida, Osaka (JP); Hiroyuki Nishida, Kyoto (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto (JP)

(21) Appl. No.: 11/916,367

(22) PCT Filed: Jun. 1, 2006
(86) PCT No.: PCT/JP2006/311011

§ 371 Date: Dec. 3, 2007

(30) Foreign Application Priority Data
Jun. 3, 2005 (JP) 2005-164093

(51) Int. Cl. F16C 11/04

(52) U.S. Cl. 403/220

(57) ABSTRACT

A rotation supporting mechanism for rotating a main body and a cover in a plane direction while overlapping the cover from a closed position at which the main body and the cover are overlapped and closed, includes a pivot portion forming an axis of a rotation of the plane direction, an eccentric cam pivoted to the pivot portion and rotated eccentrically in the plane direction, and a pressing means brought into contact with the eccentric cam so as to press the eccentric cam. A rotation smoothening member smoothening a rotation is interposed between the pivot portion and the eccentric cam.

### TECHNICAL FIELD

The present invention relates to a rotation supporting mechanism such as to be used in an opening and closing portion of a portable terminal, for example, a portable telephone, an electronic notebook, a digital camera, a digital video camera and the like. More particularly, the present invention relates to a rotation supporting mechanism and a portable terminal in which a cover is rotated in a plane direction in a state in which a main body and a cover are overlapped.

### BACKGROUND ART

Conventionally, as a rotation supporting mechanism supporting a cover and a main body of a portable terminal so as to freely open and close, there has been proposed a cover opening and closing apparatus supporting the cover and the main body of the portable telephone so as to freely open and close (refer to patent document 1).

The cover opening and closing apparatus is of a broken type (a so-called flip type) in which the cover and the main body are opened and closed in a folding manner. Accordingly, a hinge portion of the cover opening and closing apparatus is formed as a long shape in a direction of a rotating axis.

In the broken type rotation supporting mechanism in accordance with a conventional art mentioned above, in the case of opening the cover, it is necessary for a user to support the main body by one hand, and to grip the cover by the other free hand so as to open the cover. In other words, both the hands are necessary for opening the cover.

On the other hand, in recent years, various opening and closing methods have been proposed in correspondence to functions and intended uses of the portable terminal. For example, as shown in FIGS. 16A and 16B, there has been known a plane opening and closing type portable telephone 213 structured such that an upper cover 212 is rotated at about 180 degree in a plane direction so as to be opened while being overlapped from a state in which a main body 211 and the cover 212 are overlapped.

However, if the rotation supporting mechanism in accordance with the conventional art is applied to the portable terminal in which the cover is opened and closed in the plane direction as mentioned above, the direction of the rotating axis corresponding to a longitudinal direction comes to a thickness direction in which the cover and the main body are overlapped. Accordingly, the portable terminal becomes bulky, and it is hard to make the portable terminal thin.

Further, in the rotation supporting mechanism in accordance with the conventional art mentioned above, there is employed a rotation locking mechanism which can position and fasten the cover and the main body at an opened position and a closed position.

Accordingly, in the rotation supporting mechanism mentioned above, since a strong contact pressure of a spring is applied between the overlapping surfaces of the laminated constituting parts, a contact resistance is large, and a torque loss is large in the rotating operation. Therefore, it can not be applied to such an intended use that a smooth rotation is demanded so that the cover is automatically rotated through one-touch operation.

Patent Document 1: Japanese Unexamined Patent Publication No. 2003-28138

### DISCLOSURE OF THE INVENTION

### Problems to be Solved by the Invention

In view of the above-mentioned problems, an object of the present invention is to provide a rotation supporting mechanism and a portable terminal which can smoothly execute a rotation in a plane direction in a state in which a cover and a main body are overlapped.

### Means for Solving the Problems

In accordance with the present invention, there is provided a rotation supporting mechanism for rotating a main body and a cover in a plane direction while overlapping the cover from a closed position at which the main body and the cover are overlapped and closed, including: a pivot portion forming an axis of a rotation of the plane direction; an eccentric cam pivoted to the pivot portion and rotated eccentrically in the plane direction; and a pressing means brought into contact with the eccentric cam so as to press the eccentric cam, wherein a rotation smoothening member smoothening a rotation is interposed between the pivot portion and the eccentric cam.

The pressing means can be constituted by a contact portion such as a contact roller, a contact projection or the like brought into contact with the eccentric cam, and an elastic body such as a spring, a rubber or the like pressing the contact portion toward the eccentric cam.

As an aspect of the present invention, the rotation smoothening member can be formed by a sliding member sliding between the pivot portion and the eccentric cam.

The sliding member can be constituted by a member capable of reducing a friction resistance such as a member made of a fluorine raw material, a member processed by a fluorine on a surface of the member or the like, and can be formed as an appropriate shape such as a cylindrical shape, a ring shape or the like.

Further, as an aspect of the present invention, the sliding member can be formed by a cylindrical sliding ring made of a fluorine raw material.

Further, as an aspect of the present invention, the pressing means can be constituted by a contact body brought into contact with the eccentric cam, and an elastic body pressing the contact body to the eccentric cam toward a radial direction of the rotation.

Further, the present invention can provides a portable terminal using the rotation supporting mechanism.

The portable terminal can be constituted by a portable type terminal such as a portable telephone, an electronic notebook, a digital camera, a digital video camera or the like.

### EFFECT OF THE INVENTION

In accordance with the present invention, there can be provided the rotation supporting mechanism and the portable terminal which can smoothly execute the rotation in the plane direction in a state in which the cover and the main body are overlapped.

### BRIEF DESCRIPTION OF THE DRAWINGS

FIG. 1 is a perspective view of an outer appearance showing a state in which a portable telephone in accordance with an embodiment 1 is closed.

FIG. 2 is a perspective view showing a coupling correspondence relation between a main body and a cover in accordance with the embodiment 1.

FIGS. 3A and 3B are perspective views showing a state in which the cover in accordance with the embodiment 1 is rotating to the right.

FIGS. 4A and 4B are perspective views showing a state in which the cover in accordance with the embodiment 1 is rotating to the left.

FIG. 5 is an enlarged perspective view of a main portion showing a rotation supporting mechanism in accordance with the embodiment 1

FIG. 6 is an exploded perspective view showing the rotation supporting mechanism in accordance with the embodiment 1.

FIG. 7 is a perspective view of an outer appearance showing a correspondence relation in a standby state between an eccentric cam and a pressing roller in accordance with the embodiment 1.

FIGS. 8A and 8B are views of an outer appearance in the case of enlarging the eccentric cam in accordance with the embodiment 1 and viewing from a diagonally upper side and an upper surface.

FIG. 9 is a perspective view showing a state in which the rotation supporting mechanism in accordance with the embodiment 1 starts rotating to the right.

FIG. 10 is a perspective view showing a state in which the eccentric cam in accordance with the embodiment 1 starts rotating to the right.

FIG. 11 is a perspective view showing an open position at which the eccentric cam in accordance with the embodiment 1 is rotated at 180 degree.

FIG. 12 is a perspective view showing an over speed preventing state at a time when a coupling pin integrally formed with the eccentric cam in accordance with the embodiment 1 is rotated to the left.

FIG. 13 is a perspective view showing an open position at which the eccentric cam in accordance with the embodiment 1 is rotated to the right at 180 degree.

FIG. 14 is a perspective view showing an over speed preventing state at a time when the coupling pin integrally formed with the eccentric cam in accordance with the embodiment 1 is rotated to the right.

FIGS. 15A, 15B and 15C are explanatory views explaining a sliding ring in accordance with the other embodiment.

FIGS. 16A and 16B are perspective views showing a state in which a cover of a conventional portable telephone is opened.

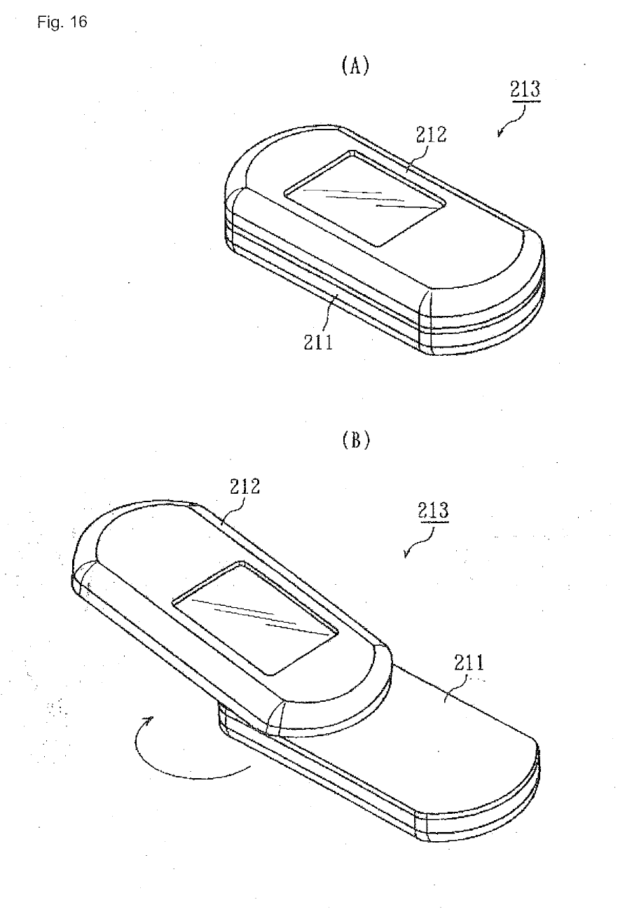

### DESCRIPTION OF REFERENCE SYMBOLS

1 portable telephone
12 main body
13 cover
14 rotation supporting mechanism
16a, 16b parallel spring
17 slider
18 pressing roller
22 eccentric cam
26 base boss
40 sliding ring

### BEST MODE FOR CARRYING OUT THE INVENTION

At a time of automating an opening operation of a cover, the cover is opened and closed by using a planar rotation supporting mechanism suitable for thinning, and a planar over speed preventing structure suitable for the planar rotation supporting mechanism.

### Embodiment 1

A description will be given of an embodiment in accordance with the present invention with reference to the accompanying drawings.

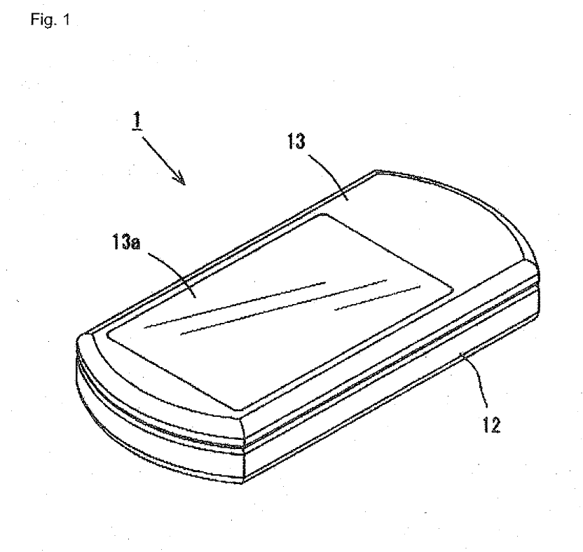

The drawings show a horizontally rotating type portable telephone. In FIG. 1, the horizontally rotating type portable telephone 1 is structured as a horizontally rotating type in which a main body 12 having a rectangular plate shape, and a cover 13 having the same shape are overlapped so as to be freely opened and closed, and the cover 13 is rotated in a plane direction so as to be freely rotated in forward and backward rotating directions in an overlapped state.

Outer surfaces such as upper surfaces and side surfaces of the main body 12 and the cover 13 are equipped with a display device 13a, an input apparatus and an antenna which are not illustrated, for utilizing various electronic information including a telephone, an electronic mail and the like.

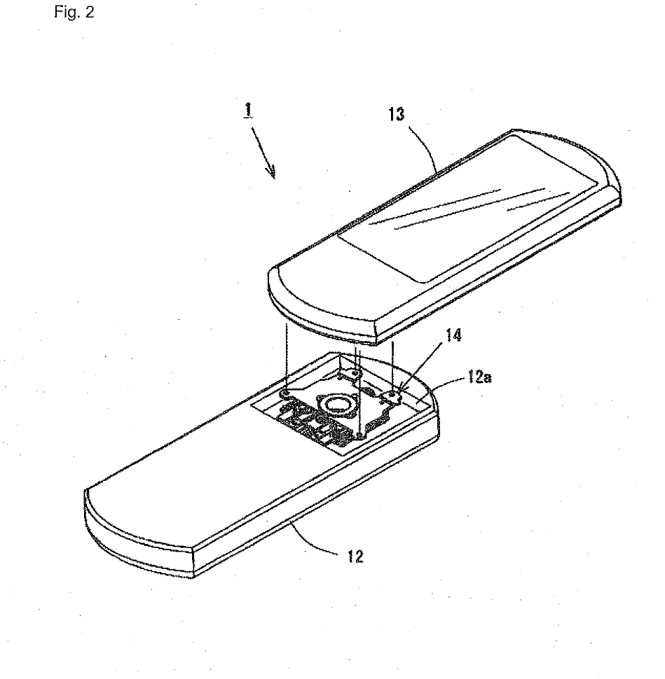

Further, at a time of coupling the main body 12 to the cover 13, the main body 12 in a lower side and the cover 13 in an upper side are coupled so as to be rotatable in the plane direction via a rotation supporting mechanism 14, as shown in FIG. 2.

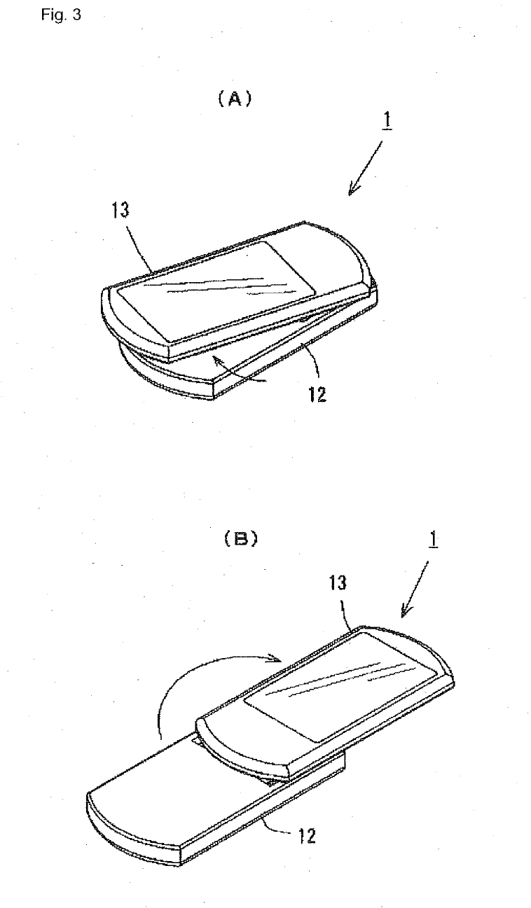

In the case of rotating the cover 13 in the plane direction, if the side surface of the closed cover 13 is little pushed leftward by a fingertip so as to be shifted, as shown in FIG. 3A, a position regulation of the rotation supporting mechanism 14 is disconnected working therewith. Accordingly, a rotating force in an opening direction can be generated in the cover 13, and the cover 13 can be automatically rotated in the opening direction on the basis of this operation so as to be opened as shown in FIG. 3B. Further, for example, the rotation is stopped in a state in which the main body 12 and the cover 13 are straight extended vertically long.

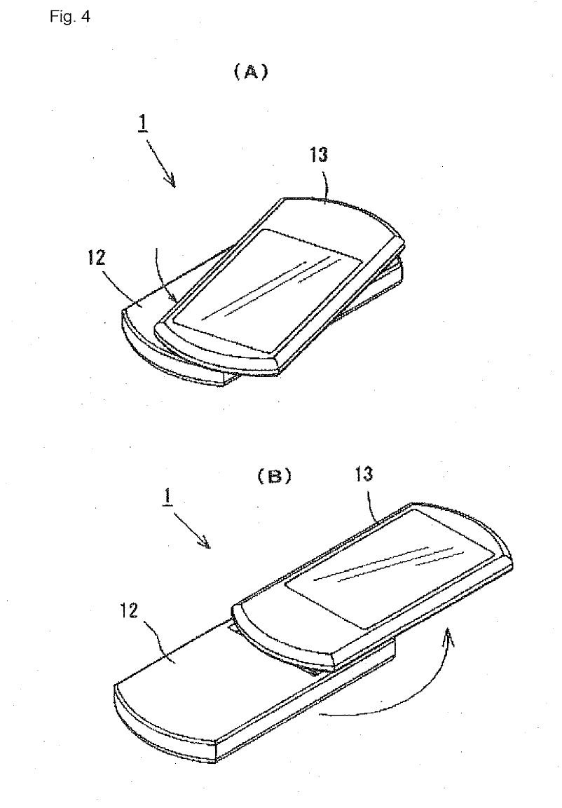

In the same manner, as shown in FIG. 4A, even in the case of little pushing the side surface of the cover 13 rightward by the fingertip, the rotating force in the opening direction is generated in the rotation supporting mechanism 14 mentioned below working with this operation, and the cover 13 can be thereafter rotated in the same direction so as be opened, as shown in FIG. 4B.

The rotation supporting mechanism 14 has a symmetrical horizontally rotating type supporting mechanism provided with a rotating force applying function of rotating and stopping rotation from a closed position at which a reference rotational position of the cover 13 is set to 0 degree to an open position at 90 degree and an opening position at 180 degree.

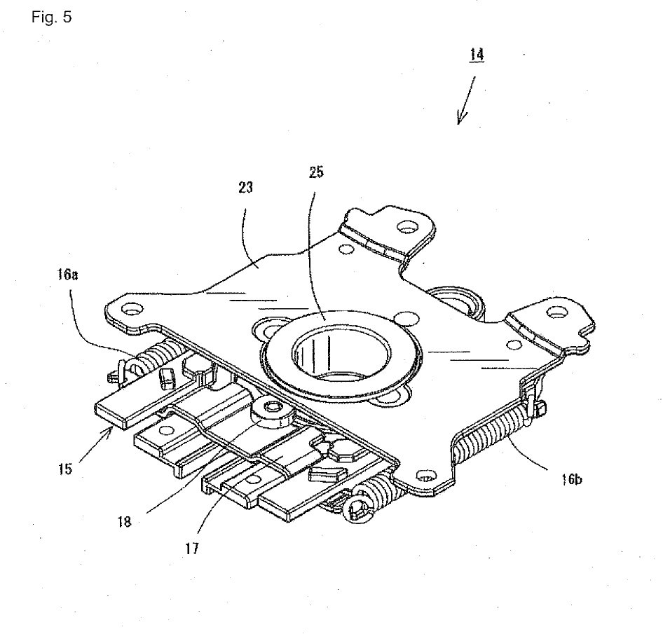

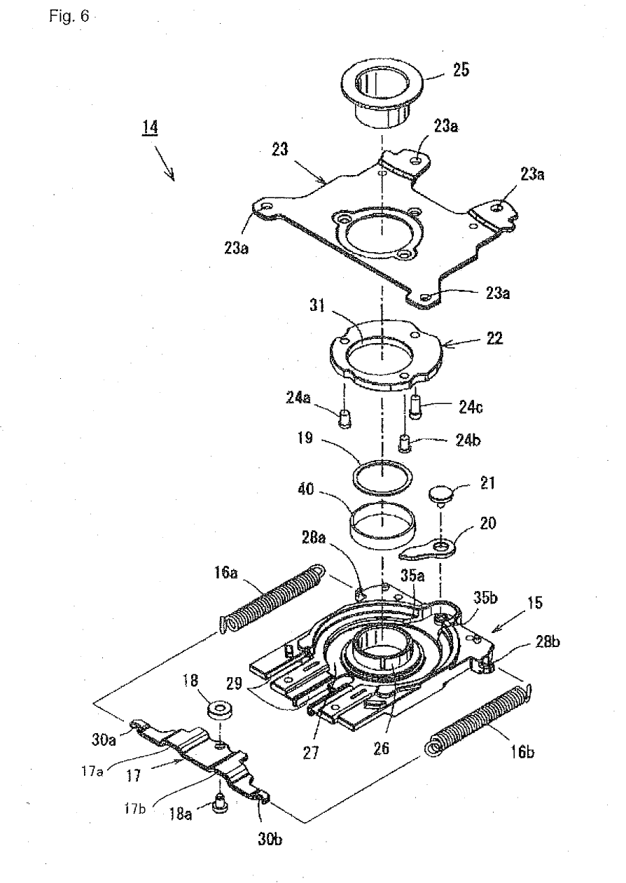

The supporting mechanism mounts parallel springs 16a and 16b, a slider 17, a pressing roller 18, a sliding ring 40, an elastic ring 19, a rotation stop lever 20, a fulcrum pin 21 of the lever, an eccentric cam 22, and a plate 23 on an upper surface of a base 15, as shown in FIGS. 5 and 6. Further, the eccentric cam 22 and the plate 23 corresponding to a rotation main portion are overlapped in a vertical direction, are integrally coupled between opposing surfaces thereof by each of coupling pins 24a, 24b and 24c, and are rotatably caulked and fixed on the base 15 by a caulking tube 25 so as to be assembled.

The base 15 has a square plate shape, and is sunk into a concave portion 12a (refer to FIG. 2) formed in one side of an upper surface of the main body 12 so as to be integrally fixed and attached. The base 15 has a base boss 26, a circular guide groove 27, spring locking portions 28a and 28b and a slide guide rail 29 on an upper surface of the base 15, and each of the parts is attached to them.

First, the base boss 26 is structured such as to be provided in a protruding manner in a center portion of the upper surface of the base 15 so as to have a short tube body, and the caulking tube 25 is inserted and guided to an inner peripheral surface of the base boss 26. Further, the sliding ring 40 is rotatably pivoted to an outer peripheral surface of the base boss 26, and the eccentric cam 22 is rotatably pivoted to an outer peripheral surface of the sliding ring 40.

In this case, the sliding ring 40 is formed as a cylindrical shape which is not expanded and contracted or is hard to be expanded and contracted by a fluorine raw material and has a fixed thickness, and is constituted by a tubular member having a smooth front surface. Further, the sliding ring 40 is interposed between the outer peripheral surface of the base boss 26 and an inner peripheral surface of the axial hole 31 of the eccentric cam 22, thereby being capable of reducing a friction resistance at a time of rotating as much as possible. Accordingly, the eccentric cam 22 can smoothly rotate with respect to the base boss 26. A width in an illustrated vertical direction of the sliding ring 40 is structured such as to be the same level as a thickness of the eccentric cam 22. In this case, since the plate 23 is fixed to the eccentric cam 22, the plate 23 is rotatably pivoted together with the eccentric cam 22.

The circular guide groove 27 having a concave cross sectional shape is formed in an outer periphery having the base boss 26 on the concentric circle, and a lower end portion of a coupling pin 24c mentioned below is rotatably interposed in the circular guide groove 27 for positioning and locking. Further, the spring locking portions 28a and 28b are formed in a protruding manner in one end portion in both right and left sides of the base 15 centering on the base boss 26, and one ends of the parallel springs 16a and 16b mentioned below are connected thereto. The slide guide rail 29 is formed in the other end side of the base 15, and the slider 17 mentioned below is slide-guided there.

Next, a description will be given of the parallel springs 16a and 16b.

The parallel springs 16a and 16b have the same shape so as to be arranged in parallel in both sides of the base 15, have an elongated coil shape so as to be expanded and contracted in a linear direction, and are structured such that one expanding and contracting end portions are locked to the spring locking portions 28a and 28b, and the other end portions are locked to the spring locking portions 30a and 30b of the slider 17 mentioned below.

Further, the spring locking portions 28a and 28b on the base 15 are set to reference positions of the expansion and contraction, and a tension action is applied to the other end sides of the parallel springs 16a and 16b. Accordingly, the pressing force is set in the same direction as a tensional direction of the parallel springs 16a and 16b in the slider 17 in the other end side, and the slider 16 in the other end side is pressed toward the eccentric cam 22.

The slider 17 mentioned above has a concavo-convex surface for slide-guiding in a lateral direction of a wide piece, the spring locking portions 30a and 30b are formed in both end pieces 17a and 17b (FIG. 6) of the slider 17, and the other end portions of the parallel springs 16a and 16b are respectively locked to the spring locking portions 30a and 30b. Accordingly, the parallel springs 16a and 16b pull the slider 17 in a pressing direction, and slides the slider 17 in an expanding and contracting direction of the springs 16a and 16b.

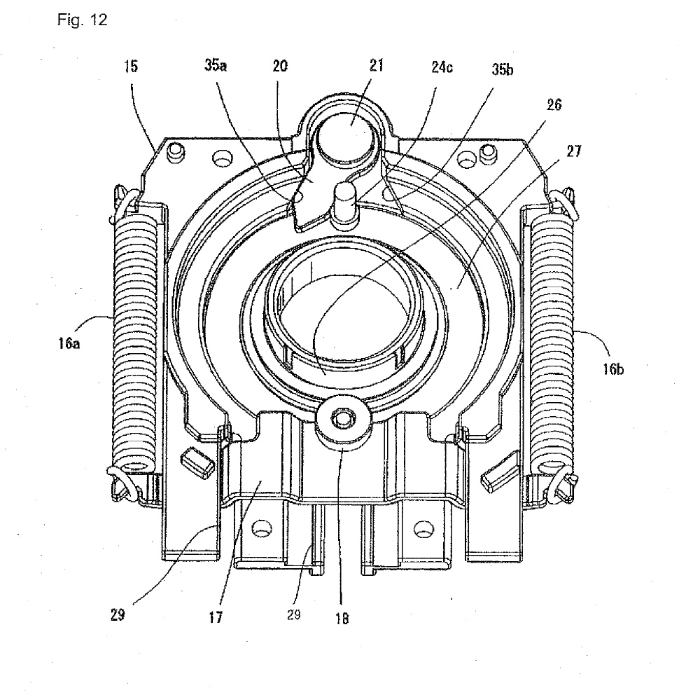

The slide rail 29 (FIGS. 6 and 12) corresponding to the concavo-convex surface of the slider 17 in a contact manner for slide-supporting is formed in an upper surface of the base 15 opposing to the sliding direction of both the end pieces 17a and 17b of the slider 17, thereby stably slide-guiding the slider 17.

Further, the pressing roller 18 constituted by a bearing is pivoted to a center portion of the slider 17 by a pin 18a so as to be rotatable in the plane direction. Further, the pressing roller 18 is positioned in a center portion of the slider 17 so as to press the eccentric cam 22 mentioned below from beginning to end by one point of the outer peripheral surface of the pressing roller 18.

A lower end portion of the pin 18a pivoting the pressing roller 18 is provided in a protruding manner on a lower surface of a center portion in a sliding width direction of the slider 17 for slide-guiding. A lower end portion of the pin 18a is engaged with the slide guide rail 29 formed on the upper surface of the base 15 so as to extend in the sliding direction and having a concave groove shape, and the lower end portion of the pin 18a positioned in the center portion of the slider 17 is effectively used for the slide guide shaft so as to slide-guide. On the basis of the sliding guide action mentioned above, it is possible to smoothly slide the slider 17 in the pressing direction.

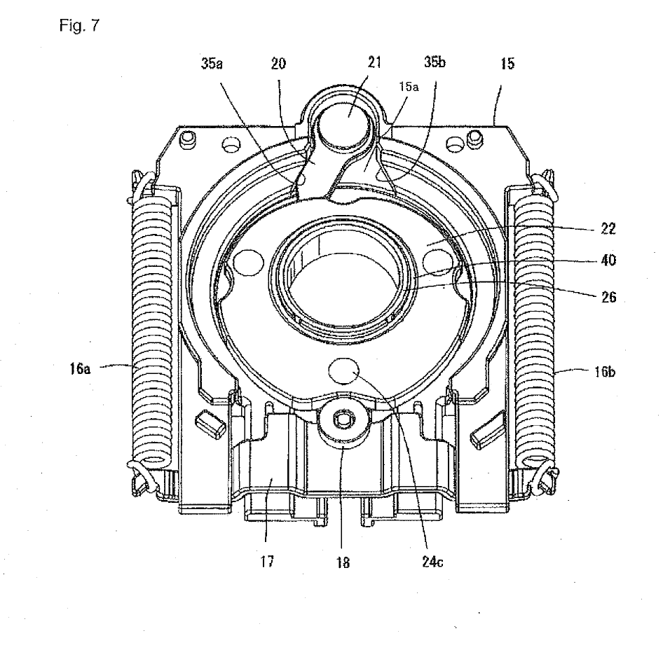

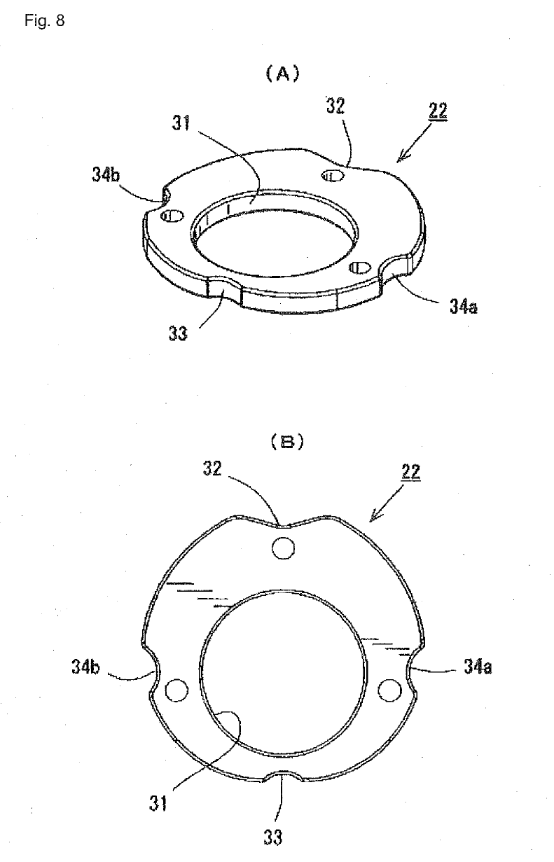

The eccentric cam 22 has an oval plate shape as shown in FIGS. 7 and 8, and has an axial hole 31 for rotatably inserting to the base boss 26 at a position which is little eccentric to one side in a longitudinal direction of the oval from the center of the oval plate shape. Further, the eccentric cam 22 is eccentrically rotated around the axial hole 31, has an open correspondence concave portion 33 receiving the roller surface of the pressing roller 18 at a minimum eccentric rotational position at which an amount of eccentricity on one of the outer peripheral surfaces being different at 180 degree becomes minimum, and has a close correspondence concave portion 32 receiving the roller surface of the pressing roller 18 at a maximum eccentric rotational position at which an amount of eccentricity on the other of the outer peripheral surfaces being different at 180 degree becomes maximum. In addition, on the outer peripheral surface of the eccentric cam 22, there are provided a left intermediate correspondence concave portion 34a and a right intermediate correspondence concave portion 34b rotation stopped at 90 degree in the process of rotation.

In this case, a description will be given of a relation between the eccentric cam 22 and the rotation. When the convex roller surface protruding in a circular arc shape of the pressing roller 18 corresponds to the close correspondence concave portion 32 having a great amount of eccentricity of the eccentric cam 22 in a concavo-convex manner, a spring pressure is increased, a pressing load and a rotational regulating force to the eccentric cam 22 are increased, and the rotation of the eccentric cam 22 is regulated. As a result, the rotation of the eccentric cam 22 is stopped at a time point that the pressing roller 18 corresponds to the close correspondence concave portion 32 of the eccentric cam 22 in a concavo-convex manner.

Further, since the amount of eccentricity of the eccentric cam 22 is reduced in accordance that the pressing roller 18 comes close to the open correspondence concave portion 33 from the close correspondence concave portion 32 at a time when the eccentric cam 22 is rotated, the pressing load applied to the eccentric cam 22 becomes low. Further, since the amount of eccentricity of the eccentric cam 22 is small at a time when the pressing roller 18 corresponds to the open correspondence concave portion 33 in a concavo-convex manner, the spring pressure becomes weak and the pressing load applied to the eccentric cam 22 becomes weakened. However, since the pressing roller 18 and the open correspondence concave portion 33 correspond to each other in a concave-convex manner, and the rotation regulating force is high, the rotation of the eccentric cam 22 is regulated. Accordingly, the rotation of the eccentric cam 22 is stopped at a time point that the pressing roller 18 corresponds to the open correspondence concave portion 33 of the eccentric cam 22 in a concavo-convex manner.

As mentioned above, when the pressing roller 18, and the close correspondence concave portion 32 or the open correspondence concave portion 33 of the eccentric cam 22 correspond in a concavo-convex manner, the motion of the pressing roller 18 moves forward and backward in the pressing direction integrally with the slider 17 so as to press toward the center of the eccentric cam 22. Accordingly, the rotation regulating force of the eccentric cam 22 exposed to the pressing force is increased, and the loads with respect to the rotating direction in both sides are balanced so as to keep a pressing balance. As a result, the rotating force is not generated in the eccentric cam 22 at the corresponding position to each of the corresponding concave portions 32 and 33.

Further, in the left and right intermediate correspondence concave portions 34a and 34b, when the convex portion protruding in the circular arc shape of the pressing roller 18 corresponds to the intermediate correspondence concave portions 34a and 34b in a concavo-convex manner, the eccentric cam 22 is rotationally stopped at the open position at 90 degree in the same manner.

Further, the eccentric cam 22 is provided with a plurality of upper ends in a protruding manner on an upper surface of a periphery of the axial hole 31 so as to vertically penetrate the coupling pins 24a to 24c mentioned above, and the plate 23 mentioned below is lapped over the coupling pins 24a to 24c from the above so as to be integrally coupled.

The plate 23 mentioned above is integrally attached to the cover 13 by fixing a coupling hole 23a open in four corners of the plate 23 to a coupling pin (not shown) of the cover 13, in a state of being integrally coupled to the eccentric cam 22, and the main body 12 and the cover 13 are integrally coupled. Further, the cover 13 is integrally rotated together with the eccentric cam 22 and the plate 23 around the base boss 26 of the main body 12. As a result, the cover 13 is rotated leftward or rightward in the plane direction.

The caulking tube 25 is inserted to an inner peripheral surface side of the base boss 26, and fixes in a caulking manner and couples upper and lower end portions to the base 15 in the lower portion so as to freely rotate the eccentric cam 22 from the plate 23 in the upper portion.

Further, the rotation supporting mechanism 14 mentioned above includes an over speed preventing mechanism for preventing the eccentric cam 22 which is going to rotate over the open correspondence concave portion 33 from rotating excessively, at a time when the eccentric cam 22 integrally formed with the cover 13 is rotated at 180 degree.

The over speed preventing structure is constituted by the rotation stop lever 20, the coupling pin 24c, and angle regulating surfaces 35a and 35b. The rotation stop lever 20 is rotatably pivoted at one end to the open position correspondence portion of the base 15 by the fulcrum pin 21, and is provided at the other end so as to be rotatable in the rotating direction of the eccentric cam 22.

In this case, a tapered notch concave portion 15a is formed on an upper surface of the base 15. In the notch concave portion 15a (FIG. 7), a left notch end surface of the tapered shape is provided in the angle regulating surface 35a in a leftward rotating direction, and a right notch end surface of the tapered shape is provided in the angle regulating surface 35b in a rightward rotating direction. Accordingly, an amount of rotation of the rotation stop lever 20 is regulated in such a manner that the rotation of the rotation stop lever 20 is within the tapered notch concave portion 15a.

In the open position correspondence portion side of the eccentric cam 22 corresponding in a locking manner to the rotation stop lever 20 on the base 15 by the open position correspondence portion, a lower end portion of the coupling pin 24c is suspended onto a lower surface of the open position correspondence portion of the eccentric cam 22 for positioning.

Further, when the rotation stop lever 20 and the coupling pin 24c correspond in a locking manner in the open position correspondence portion by rotating the eccentric cam 22 in the opening direction, the rotation stop lever 20 is further pressed in the rotating direction of the eccentric cam 22 so as to be rotated, and is brought into contact with one of the angle regulating surfaces 35a and 35b for aligning the open position. Accordingly, the eccentric cam 22 is accurately rotationally regulated to the open position at 180 degree.

In this case, since the rotation supporting mechanism 14 has the symmetrical structure, the eccentric cam 22 executes the same symmetrical motion from the closed position at 0 degree to the open position rotated at 180 degree, and it is possible to easily open the cover 13 integrally formed with the eccentric cam 22 in both directions. Accordingly, even if the cover 13 is rotated leftward or rightward, it is possible to accurately rotate and stop rotation at the open position rotated at 180 degree.

Further, the parallel springs 16a and 16b pressing the cover 13 in the rotating direction press in a horizontal direction which is perpendicular to a pivoting direction of the cover 13, a contact resistance between upper and lower surfaces of the eccentric cam 22 laminated in the pivoting direction is small, and a torque loss becomes small. Further, at a time of the locking motion at the cover open position, it is possible to accurately position, and it is possible to prevent the cover from excessively rotating, on the basis of the rotation stop structure in which the rotation stop lever 20 and the coupling pin 24c are corresponded in a locking manner and the rotation stop lever 20 is position regulated to the angle regulating surfaces 35a and 35b, in addition to the concavo-convex correspondence between the correspondence concave portions 32 and 33 of the eccentric cam 22 mentioned above and the convex surface of the pressing roller 18.

Further, the rotation stop lever 20 is not rotated around the base boss 26 of the eccentric cam 22, but is little rotated while being provided with the center of rotation in the open position correspondence portion of the other base 15. Accordingly, the rotation stop lever 20 is possible to incorporate in the base 15 compactly. Further, it is possible to position in correspondence to both the rotating directions, by regulating the rotation stop lever 20 by the angle regulating surfaces 35a and 35b so as to lock, only at a time when the eccentric cam 22 rotates leftward or rightward so as to reach the open position correspondence portion at 180 degree.

When rotating the eccentric cam 22 leftward, the rotation stop lever 20 is swung to the left at an amount of aligning rotation working with the leftward rotation of the eccentric cam 22 near 180 degree, and the rotation stop lever 20 is brought into contact with the angle regulating surface 35b so as to regulate the rotation. In the same manner, when rotating the eccentric cam 22 rightward, the rotation stop lever 20 is swung to the right at an amount of aligning rotation working with the rightward rotation of the eccentric cam 22 near 180 degree, and the rotation stop lever 20 is brought into contact with the angle regulating surface 35a so as to regulate the rotation. Accordingly the eccentric cam 22 is accurately regulated rotationally to the defined open position, and the excessive rotation of the eccentric cam 22 is regulated.

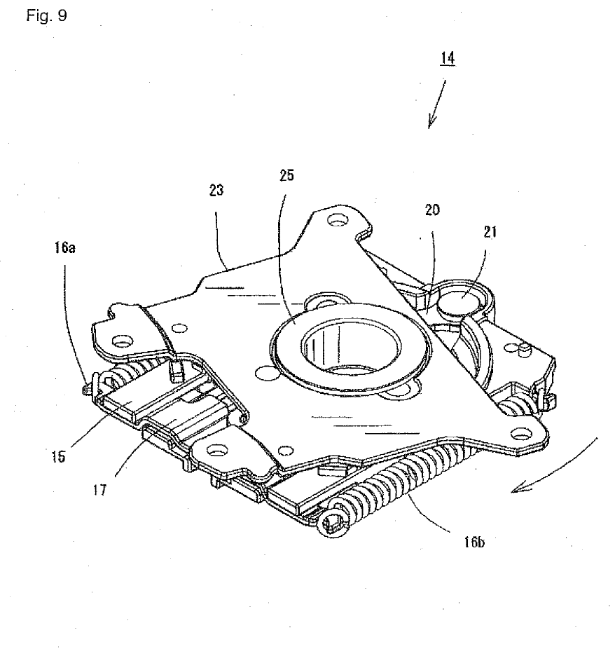

A description will be given of an opening and closing motion of the rotation supporting mechanism 14 structured as mentioned above with reference to motion explanatory views in FIGS. 9 to 12.

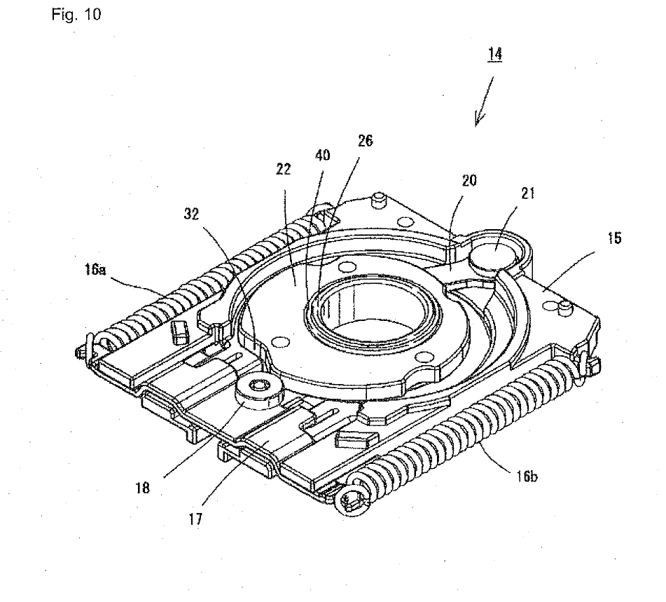

Regularly, in a standby state of the portable telephone 1, the portable telephone is in the closed state (refer to FIG. 1) in which the main body 12 and the cover 13 are closed and overlapped. If a user holds the portable telephone 1 in this closed state by one hand, and little pushes the cover 13 by a fingertip in the holding side, for example, in a rightward plane direction so as to shift (refer to FIG. 3), the plate 23 of the rotation supporting mechanism 14 is little rotated in the rightward direction, as shown in FIG. 9. At this time, as shown in FIG. 10, the eccentric cam 22 is rotated little in the rightward direction, and the eccentric cam 22 is little rotated rightward by a disconnection of the concavo-convex correspondence between the rotating roller 18 and the close correspondence concave portion 32. This rotation is very smoothly carried out on the basis of the existence of the sliding ring 40.

Further, in this case, the concavo-convex correspondence between the close correspondence portion 32 of the eccentric cam 22 and the pressing roller 18 is little shifted, and the correspondence is shifted at the mutual close positions, whereby the eccentric cam 22 energetically starts rotating in the rightward direction in such a manner as to avoid the pressing force of the pressing roller 18 pressing at a high load.

When the eccentric cam 22 is rotated by the pressing force as mentioned above, the pressing force in the horizontal direction is converted into the rotating force by the eccentric cam 22, however, this conversion is efficiently carried out because the sliding ring 40 reduces the friction force.

Further, when the eccentric cam 22 is rotated at 90 degree from the close correspondence concave portion 32, the right intermediate correspondence concave portion 34b and the pressing roller 18 correspond in a concavo-convex manner. The cover 13 integrally formed with the eccentric cam 22 is rotation regulated to the position which is sideways at 90 degree at the concavo-convex correspondence time point, and the pressing balance is kept and the cover 13 is rotation-stopped.

Further, if the cover 13 is rotated to the right from this position, the eccentric cam 22 starts rotating in the rightward direction, and the eccentric cam 22 is rotated from the right intermediate correspondence concave portion 34b to the open correspondence concave portion 33. At this rotating time, the pressing force is efficiently converted into the rotating force as mentioned above.

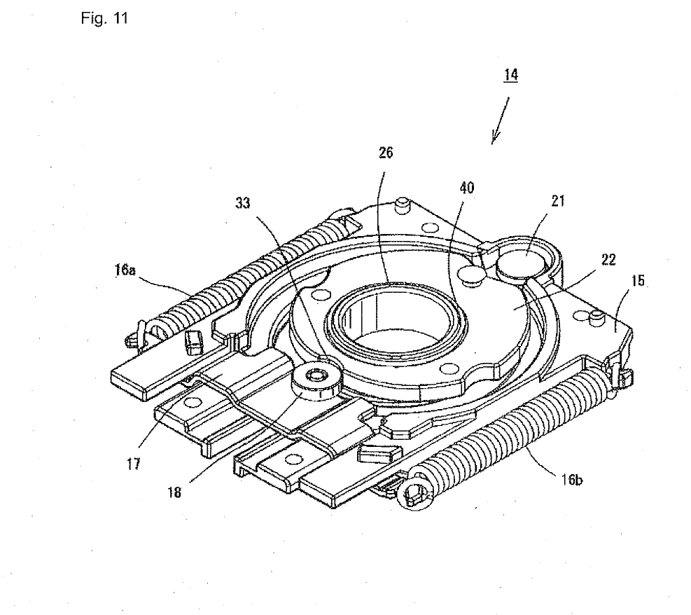

Further, as shown in FIG. 11, the open correspondence concave portion 33 and the pressing roller 18 correspond in a concavo-convex manner at a time when the eccentric cam 22 is rotated at 180 degree. The eccentric cam 22 is rotationally regulated at the concavo-convex corresponding time point, and the pressing balance is kept and the rotation is stopped.

As mentioned above, if the position of the maximum eccentric rotation of the high pressing load is set to the close correspondence concave portion 32 of the cover 13, the eccentric cam 22 is energetically rotated at 180 degree only by little rotating the eccentric cam 22 from the close correspondence concave portion 32. Accordingly, the cover 13 integrally formed with the eccentric cam 22 is thereafter automatically rotation stopped at the rotational positions at 90 degree and 180 degree only by initially rotating manually. Accordingly, the user can set the cover 13 in the open state in accordance with a one-touch opening operation of only little pushing the cover 13 by one hand, so that a semiautomatic opening motion can be achieved and an opening operability of the portable telephone 1 is improved. On the contrary, in the case of returning the cover 13 to the original closed state, the user can restore by rotating the cover 13 at 90 degree or 180 degree in an inverted rotating direction by the hand.

In this case, since the rotation supporting mechanism 14 has the symmetrical structure, the opening operation mentioned above can be executed in the same manner not only in the rightward rotation but also in the leftward rotation.

Next, a description will be given of the rotation regulating motion of the cover 13 regulating the excessive rotation at a time of rotating the cover 13 at 180 degree so as to open.

When the cover 13 is in the closed state, the rotation stop lever 20 is in a free state in which no load is applied so as to stand ready to rotate. If the eccentric cam 22 is little rotated leftward in accordance with the rotating operation of the cover 13 from this standby state, the coupling pin 24c integrally formed with the eccentric cam 22 is also rotated. Further, when the coupling pin 24c is rotated at 180 degree, the coupling pin 24c somewhat pushes and rotates the rotation stop lever 20, and the rotation stop lever 20 is brought into contact with the left angle regulating surface 35a so as to be rotation-regulated.

Accordingly, in the case that the opening operation for leftward rotating the cover 13 at 180 degree is carried out, the rotation stop lever 20 and the left angle regulating surface 35a regulate the further leftward rotation so as to maintain the open position. Therefore, it is possible to regulate the excessive rotating operation of the cover 13. Further, if the cover 13 is rotated at 180 degree in an inverse direction, the cover 13 is returned to the original position.

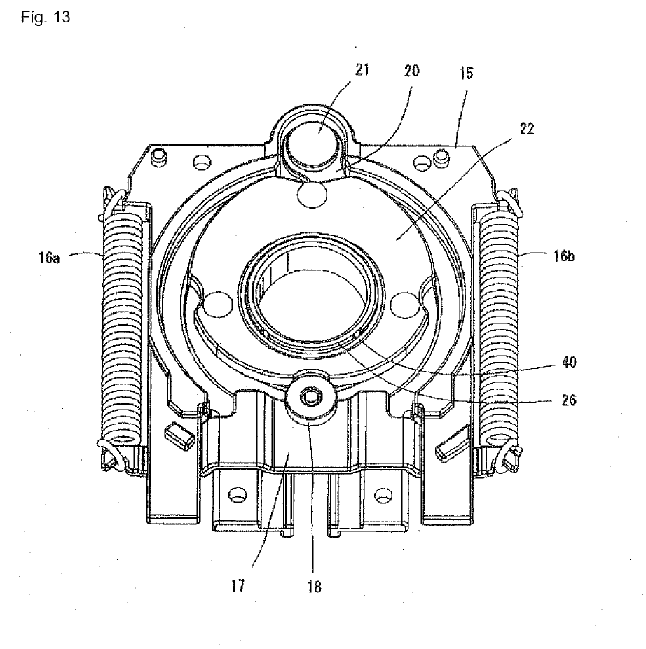

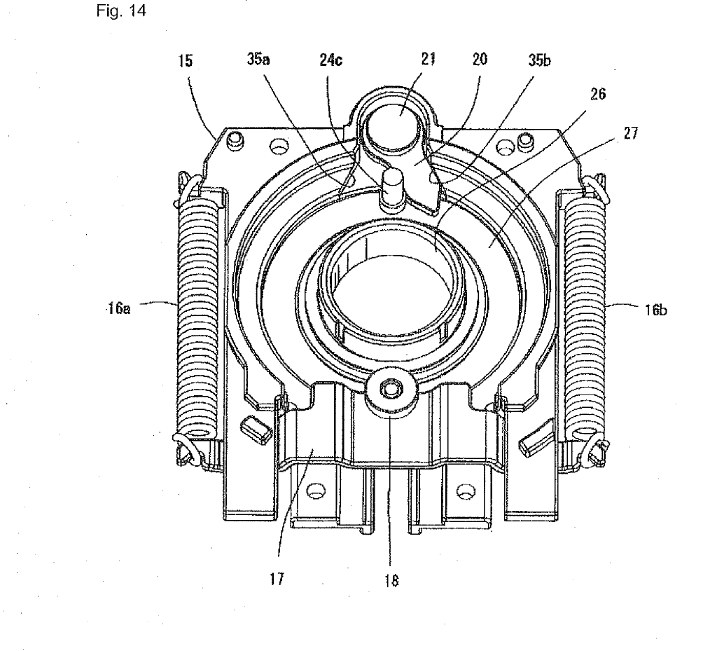

In the same manner, even in the case of rightward rotating the cover 13 so as to open, it is possible to regulate the excessive rotation of the cover 13 in the same manner as the leftward rotation mentioned above, as shown in FIGS. 13 and 14 because the rotation supporting mechanism 14 has the symmetrical structure.

Further, it is possible to regulate the amount of each of rightward rotation and leftward rotation of the cover 13 at 180 degree. Accordingly, it is possible to regulate the wiring in the inner portion to the motion within the rotating range equal to or less than 180 degree, and the wiring in the inner portion is not exposed to an excessive twisting action. Therefore, even if the cover is frequently opened and closed, the wiring is stably maintained.

Further, the elastic ring 19 is interposed between the opposing surfaces opposing up and down in the plate 23 attached to the cover 13 and the base 15 attached to the main body 12 so as to play a part of absorbing a fluctuation in the vertical direction. The elastic ring 19 may be made of a rubber or a metal, and may have an elasticity in a vertical direction. Further, it is possible to improve a contact stability of the cover 13 and suppress a stagger of the cover 13 by interposing the elastic ring 19.

As described above, the rotation supporting mechanism 14 is provided with the base boss 26 forming an axis of rotation in the plane direction, the eccentric cam 22 pivoted to the base boss 26 and rotating so as to be eccentric in the plane direction, and the pressing roller 18 brought into contact with the eccentric cam 22 so as to press the eccentric cam 22. Further, since the sliding ring 40 smoothening the rotation is interposed between the base boss 26 and the eccentric cam 22, it is possible to execute a smooth semiautomatic rotation.

In the rotation supporting mechanism 14 in accordance with the present embodiment, the pressing force in the horizontal direction which the pressing roller 18 presses the eccentric cam 22 in the horizontal direction on the basis of the elastic force of the parallel springs 16a and 16b is converted into the rotating force on the basis of the cam shape of the eccentric cam 22. Particularly, it is possible to improve a converting efficiency in particular by the sliding ring 40.

Further, since the friction resistance at a time of rotating can be reduced by the sliding ring 40, it is possible to achieve the semiautomatic rotation while weakening the elastic force of the parallel springs 16a and 16b in comparison with the case that the sliding ring 40 does not exist. Accordingly, it is possible to easily prevent each of the parts from being broken and deformed due to the fact that the elastic force of the parallel springs 16a and 16b is too strong, as typified by the breakage of the bearing (the pressing roller 18), the abrasion of the contact surface at a time of rotating, and the spring bend of the parallel springs 16a and 16b.

Further, since the sliding ring 40 slides between the base boss 26 and the eccentric cam 22, it is possible to increase a durability on the basis of a simple structure. In other words, in comparison with the case that the bearing is used in place of the sliding ring 40, it is possible to improve a durability.

Further, since the sliding ring 40 is formed by the cylindrical sliding ring made of the fluorine raw material, the sliding ring 40 can be constructed by the existing raw material.

Further, since the portable telephone 1 is provided with the rotation supporting mechanism 14, it is possible to provide the portable telephone 1 which effectively makes good use of the rotation supporting mechanism 14 and has a high convenience.

In the correspondence between the structure in accordance with the present invention and the embodiment mentioned above, the portable terminal of the present invention corresponds to the portable telephone 1, the elastic body corresponds to the parallel springs 16a and 16b, the pressing means corresponds to the parallel springs 16a and 16b, the slider 17 and the pressing roller 18, the contact body corresponds to the pressing roller 18, the pivot portion corresponds to the base boss 26, and the rotation smoothening member and the sliding member correspond to the sliding ring 40, respectively. However, the present invention is not limited only to the structure in accordance with the embodiment mentioned above, but a lot of embodiments can be obtained.

For example, in the embodiment mentioned above, the base 15 of the rotation supporting mechanism 14 is attached to the main body 12, and the plate 23 is attached to the cover 13, however, the structure can be made inversely such that the base 15 is attached to the cover 13, and the plate 23 is attached to the main body 12. Further, in the embodiment mentioned above, the symmetrical eccentric cam 22 is used, however, the structure is not limited to this, but the speeds of the leftward rotation and the rightward rotation at a time of the opening operation may be set to be changed by setting the shape of the eccentric cam asymmetrically, or differentiating the surface resistances of the right and left outer peripheral surfaces of the eccentric cam 22. Further, there is shown the embodiment in which the cover is rotated and stopped rotation at the open position at 90 degree and the open position at 180 degree, however, the structure is not limited to this, but can be limited to be rotated and stopped rotation only at the open position at 180 degree.

Further, the eccentric cam 22 may be formed as a symmetrical circular arc shape from the close correspondence concave portion 32 to the open correspondence concave portion 33 without being provided with the left intermediate correspondence concave portion 34a and the right intermediate correspondence concave portion 34b. In this case, the open position is not fixed at 90 degree, but the close position is fixed at 0 degree and the open position is fixed at 180 degree. Accordingly, if the initial rotation is manually carried out from 0 degree, the automatic rotation is achieved to 180 degree at a stroke.

Further, the over speed preventing structure employs the rotating type rotation stop lever 20, however, the rotation stop lever 20 may be structured as a slide type. In this case, the structure may be made such as to bring the coupling pin 24c coupled to the eccentric cam 22 into contact with a foot portion of a T-shape so as to accurately rotationally regulate the eccentric cam 22 to the open position at 180 degree, by forming the rotation stop lever 20 as a T-shaped form in a plan view so as to be slidable in parallel to a width direction (a lateral direction in FIG. 7).

Further, one sliding ring 40 is interposed between the base boss 26 and the eccentric cam 22, however, the structure is not limited to this, but a plurality of sliding rings 40 may be interposed. In this case, a plurality of sliding rings 40 may be concentrically interposed while being overlapped as a multilayer structure, or a plurality of ring-shaped sliding rings 40 may be interposed while being laminated in a vertical direction.

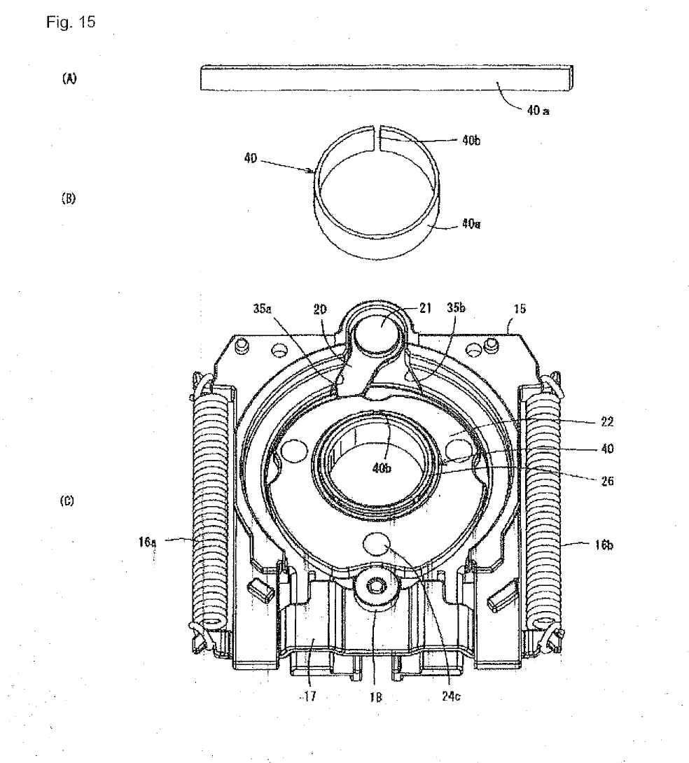

Further, the sliding ring 40 may be formed as the other shapes. For example, a sliding sheet 40a formed as a rectangular sheet shape which is not expanded and contracted or is hard to be expanded and contacted while having a fixed thickness by a fluorine raw material, and having a smooth front surface as shown in a perspective view in FIG. 15A, may be curved as a ring shape so as to form an approximately cylindrical shape as shown in a perspective view in FIG. 15B so as to form the sliding ring 40.

At this time, the structure may be preferably made such that the length in the longitudinal direction of the sliding sheet 40a is formed a little shorter than a circumferential length of an outer periphery of the base boss 26, and a gap 40b is formed between both end portions (between opposing portions opposing after being curved) in the longitudinal direction of the sliding sheet 40a in a state of being interposed between the base boss 26 and the eccentric cam 22. The gap 40b may be constituted by a gap having a suitable interval. However, the gap 40b is structured as the gap having the same level of interval as a thickness of the sliding sheet 40a in this embodiment. Further, a width in a short direction of the sliding sheet 40a is structured as the same level of width as the thickness of the eccentric cam 22.

At a time of interposing the sliding sheet 40a as the sliding ring 40 between the base boss 26 and the eccentric cam 22, the sliding ring 40 may be formed as shown in FIG. 15C by pushing one corner of the sliding sheet 40a into the gap between the base boss 26 and the eccentric cam 22, and sequentially pushing a whole from the corner portion.

The same effect as the embodiment described previously can be obtained by interposing the sliding ring 40 structured as mentioned above between the base boss 26 and the eccentric cam 22.

Further, since it is not necessary to process the sliding ring 40 in the tube shape such as the embodiment (FIG. 6) described previously, it is possible to achieve a further cost reduction.

Further, since the gap 40b is provided in the sliding ring 40, both end portions of the sliding sheet 40a do not lap over each other so as to generate a rotation error, and it is possible to stably obtain a smooth rotation having a reduced friction resistance.

In this case, each of a plurality of sliding sheets 40a may be curved as a ring shape, and each of the sliding rings 40 may be overlapped concentrically as a multilayer structure between the base boss 26 and the eccentric cam 22.

### INDUSTRIAL APPLICABILITY

The present invention can be used in the opening and closing portion of the portable terminal such as the electronic notebook, the digital camera, the digital video camera and the like without being limited to the portable telephone mentioned above.

1. A rotation supporting mechanism for rotating a main body and a cover in a plane direction while overlapping the cover from a closed position at which the main body and the cover are overlapped and closed, comprising:
a pivot portion forming an axis of a rotation of the plane direction;
an eccentric cam pivoted to the pivot portion and rotated eccentrically in the plane direction; and
a pressing means brought into contact with the eccentric cam so as to press the eccentric cam,
wherein a rotation smoothening member smoothening a rotation is interposed between the pivot portion and the eccentric cam.

2. A rotation supporting mechanism as claimed in claim 1, wherein the rotation smoothening member is formed by a sliding member sliding between the pivot portion and the eccentric cam.

3. A rotation supporting mechanism as claimed in claim 2, wherein the sliding member is formed by a cylindrical sliding ring made of a fluorine raw material.

4. A rotation supporting mechanism as claimed in claim 3, wherein the pressing means is constituted by a contact body brought into contact with the eccentric cam; and an elastic body pressing the contact body to the eccentric cam toward a radial direction of the rotation.

5. A portable terminal using the rotation supporting mechanism as claimed in claim 1.

6. A portable terminal using the rotation supporting mechanism as claimed in claim 2.

7. A portable terminal using the rotation supporting mechanism as claimed in claim 3.

8. A portable terminal using the rotation supporting mechanism as claimed in claim 4.
